(19) United States
(12) Patent Application Publication
(10) Pub. No.: US 2006/0056555 A1
(43) Pub. Date: Mar. 16, 2006

(54) Syncronization signal detection apparatus and synchronization signal detection method

(75) Inventors: Yuuko Oono, Kanagawa (JP); Koji Tada, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Shinagawa-ku (JP)

(21) Appl. No.: 10/520,929

(22) PCT Filed: Jul. 9, 2003
(86) PCT No.: PCT/JP03/08718

§ 371 Date: Jan. 11, 2005

(30) Foreign Application Priority Data
Jul. 19, 2002 (JP) 2002-210658

(51) Int. Cl. H04L 7/00

(52) U.S. Cl. 375/354

(57) ABSTRACT

A synchronization signal detection apparatus and a synchronization signal detection method for improving the reading performance of an input signal after the dissolution of a defect state or the like. Under a predetermined condition after no synchronization signals from an input signal have been detected in predetermined detection periods and the interpolation of synchronization signals has been started, the judgment about whether each of the synchronization signals detected from the input signal continuously is detected at normal timing or not is performed. Then, according to the judgment result, the resynchronization operation of the synchronization signals detected from the input signal and reproducing synchronization signals is performed. Thereby, the state in which the synchronization signals having different timing from originally expected timing are used owing to the interpolation of synchronization signals can be immediately dissolved.

### TECHNICAL FIELD

The present invention relates to a synchronization signal detection apparatus and a synchronization signal detection method in the synchronization signal detection apparatus.

### BACKGROUND ART

Digital data which has a predetermined format and has been modulated by a record coding modulation such as Eight to Fourteen Modulation (EFM) and EFM+ is recorded on an optical disc such as a compact disc (CD) and a digital versatile disc (DVD). Then, in the above-mentioned format, the digital data is recorded on the disc in the sequence by the frame including a predetermined sync pattern.

Accordingly, on the side of an apparatus for performing the reproduction of the optical disc, a synchronous detection circuit for detecting the predetermined sync pattern (frame synchronization signal) included in read digital data is provided to recognize the section of each frame. Then, the digital data read from the optical disc can be suitably reproduced.

Now, in the case where a scratch or an attachment exists' on the read surface of a loaded optical disc in the above-mentioned optical disc reproducing apparatus, there is the case where the sync pattern included in the read digital data cannot be detected. Then, it becomes difficult to recognize the section of each frame consequently, and there is the possibility that the read digital data cannot be reproduced appropriately.

In such a case, on the side of the reproducing apparatus, the state in which the amplitude level of a reproducing RF signal which is equal to a predetermined value cannot be obtained owing to the above-mentioned scratch or the like on the disc (the so-called defect state) is detected.

Then, by the detection of the defect state as described above, each unit is made to recognize that the reproducing apparatus is in the state in which the data-reading from the disc cannot be correctly performed, and is made to perform necessary control operation according to the state.

Now, in the optical disc reproducing apparatus, there is the case where the same signal pattern as the sync pattern is detected in a data part which is not the original frame sync owing to the disturbance of a phase locked loop (PLL) or a bit defect, though the generation of the above-mentioned defect state caused by the scratch or the like on the disc is not resulted.

Accordingly, the synchronous detection circuit in the optical disc reproducing apparatus performs sync detection only in fixed periods before and after the timing at which the original sync pattern is predicted to appear.

That is to say, the synchronous detection circuit generates a signal which is called as a window signal and is synchronized with the timing at which the original sync pattern is predicted to appear, and recognizes only the sync pattern detected in the window as correct frame sync.

Then, the synchronous detection circuit prevents the use of an erroneously detected pseudo sync pattern as reproducing processing sync.

Moreover, besides this, the optical disc reproducing apparatus is also provided with a protection circuit for interpolating frame sync in the case where the above-mentioned defect state is detected and no frame sync can be detected (sync omission), or in the case where no frame sync can be detected in the window. The protection circuit is combined with the synchronous detection circuit to be used.

That is to say, in case of the above-mentioned sync omission, or in the case where the detection position of the sync pattern is shifted, the frame sync from read data cannot be used. Accordingly, the optical disc reproducing apparatus interpolate the frame sync (interpolation sync) at the timing expected to be appropriate.

The operation is called as the so-called forward guard operation.

By the forward guard operation as described above, a temporary omission or shift of the sync can be protected. However, in the case where the omission or the shift described above is continuous, there is the possibility that a difference is produced between the reproducing sync (namely the interpolation sync here) and an originally expected sync position for data reproduction, and that the data cannot be normally reproduced.

Accordingly, the above-mentioned protection circuit counts the number of times of the cases where no detection sync has appeared in the above-mentioned window. The protection circuit opens the window at the time when the counted value reaches a certain fixed number of times (forward guard times) to synchronize the timing of the window signal with the timing of the detection sync.

Then, by the performance of the resynchronization operation as described above, any shift generated between the timing of the interpolation sync and that of the frame sync recorded on a disc actually can be dissolved.

The operation obtained by the synchronous detection circuit and the protection circuit, which has been described above, are described by using the timing charts of FIGS. 6A-6G.

Incidentally, in these figures, the case where the forward guard times in the protection circuit is set to be ten times as shown in the figures is exemplified to be described.

First, in these figures, in a period before a shown time point t1, detection sync shown in FIG. 6B is detected in the periods when a signal WINDOW shown in FIG. 6C is H, and in the period the operation is in the state in which the frame sync is detected at normal timing. That is to say, the signal WINDOW is a signal for the so-called window protection, which sets its periods of being H level as window periods.

Then, in this state, reproducing sync shown in FIG. 6G is in the state of being synchronized with the timing of the detection sync.

It is supposed that the amplitude level of a reproducing RF signal becomes a predetermined value or less from this state owing to a scratch or the like on the disc from this state and a signal DEFECT shown in FIG. 6A rises to the H level at the time point t1 in the figures. Then, besides this, it is supposed that no sync is detected in a window shown as a period “A” in the figures on and after the time point t1.

Then, in response to this, the count of forward guard counted values shown in FIG. 6E is started in synchronization with a time point t2 being the fall timing of the window in which no detection sync has appeared. Thus, the count of the number of times of the detection by which no sync is detected in the window is started.

Moreover, in response to the situation in which no detection sync is detected in the windows as described above, sync is interpolated as described above, and the interpolation sync is output as the reproducing sync, as shown in the figures.

Now, it is supposed that the frame sync is started to be re-detected at a time point t3 shown in the figures after the estimated pass of the defect state by the turn of the signal DEFECT to the L level as shown in the figures in the period on and after the time point t2. Moreover, at this time, it is also supposed that the thus re-detected frame sync is detected at the timing out of the windows as shown in the figures after the pass of the defect period.

In this case, the sync re-detected after the pass of the defect state as described above is not used as the reproducing sync until the forward guard times (forward guard counted value) becomes equal to or more than a predetermined number of times owing to the performance of the forward guard operation described above.

That is to say, because ten times is set as the forward guard times in this case, the interpolation sync is used until the forward guard counted value shown in FIG. 6E becomes “ten” as it is seen by referring to FIGS. 6D and 6G.

When the forward guard counted value reaches “10”, a signal WINDOW-OPEN shown in FIG. 6F starts to take the H level at the timing of the rise of the signal WINDOW immediately after the time point at which the counted value has become “10” as shown in the figure. Then, the window immediately after the time when the forward guard counted value has become “ten” is opened in company with the rise of the signal WINDOW-OPEN. At a shown time point t4, the signal WINDOW starts to synchronize with the detection sync.

Consequently, the detection sync is started to be detected in the windows, the detection sync is started to be used again as the reproducing sync shown in FIG. 6G. That is to say, the resynchronization of the sync has been completed consequently.

Incidentally, though it is not shown here, as the actual operation of the synchronous detection circuit and the protection circuit, the operation called as the so-called backward guard operation is also additionally performed after the resynchronization of the sync over the forward guard times in the state in which the sync after the re-detection in the way described above does not accord with the range within any window.

That is to say, the number of times of the detection of the detection sync in the windows after the resynchronization is counted similarly to the forward guard operation. When the counted value becomes a certain fixed value, the present detection sync is ascertained to be at a correct position as the data reproducing sync. Then, the use of erroneous detection sync as the reproducing sync is thereby avoided.

Thus, according to the conventional forward guard operation, the interpolation sync is interpolated by the number of times corresponding to the forward guard times in the case where the frame sync re-detected after the dissolution of the defect state in the way described above is detected at the outside of any windows.

Now, the following case is considerable: the case where each time of the frame sync re-detected after the pass of the defect is detected at a normal interval, though the frame sync is detected, for example, out of the windows, on and after the time point t3 shown in FIGS. 6A-6G.

That is to say, there is also the possibility that each time of the frame sync re-detected after the dissolution of the defect state in the way described above can be obtained at the timing appropriate for the reproducing sync.

However, on the basis of the above description, according to the conventional forward guard operation, the resynchronization of the sync is not performed until the interpolation sync has been interpolated by the number of times corresponding to the forward guard times. Consequently, even if each time of the frame sync re-detected in the way described above is detected at the appropriate timing, the resynchronization with the sync cannot be immediately performed.

Consequently, in this case, even if the frame sync is accurately detected, the data reproduction is performed by using the interpolation sync different from the sync at the originally expected sync position as the data reproducing sync until the sync is re-synchronized.

That is to say, there is the case where data reading performance is rather lowered by performing the conventional forward guard operation.

### DISCLOSURE OF THE INVENTION

Accordingly, in consideration of the problem described above, the present invention configures the synchronization signal detection apparatus as follows.

That is to say, first, the synchronization signal detection apparatus is provided with synchronization signal detection means for inputting a signal formed by a frame in accordance with a predetermined format to detect a synchronization signal to be inserted into the frame, and interpolation means for interpolating a synchronization signal generated according to detection timing of the synchronization signal detected by the synchronization signal detection means as a reproducing synchronization signal when the synchronization signal detection means has been unable to detect any synchronization signal within a predetermined detection period.

Then, the synchronization signal detection apparatus is provided with judgment means for performing judgment about whether the synchronization signal continuously detected by the synchronization signal detection means is at normal timing or not under a predetermined condition after a start of the interpolation of the synchronization signal by the interpolation means, and resynchronization means for outputting the synchronization signal detected by the synchronization signal detection means as the reproducing synchronization signal according to a judgment result of the judgment means.

Moreover, the present invention sets a synchronization signal detection method as follows.

That is to say, the synchronization signal detection method executes a synchronization signal detection process for inputting a signal formed by a frame in accordance with a predetermined format to detect a synchronization signal to be inserted into the frame, and an interpolation process for interpolating a synchronization signal generated according to detection timing of the synchronization signal detected by the synchronization signal detection process as a reproducing synchronization signal when no synchronization signal has been able to be detected within a predetermined detection period by the synchronization signal detection process. Moreover, the synchronization signal detection method executers a judgment process for performing judgment about whether the synchronization signal continuously detected by the synchronization signal detection process is at normal timing or not under a predetermined condition after a start of the interpolation of the synchronization signal by the interpolation process, and resynchronization process for outputting the synchronization signal detected by the synchronization signal detection process as the reproducing synchronization signal according to a judgment result of the judgment process.

According to the present invention, the judgment about whether the synchronization signal continuously detected from the input signal is detected at normal timing or not is performed under the predetermined condition after the start of the interpolation of the synchronization signal after the synchronization signal has not been detected from the input signal within the predetermined detection period.

Then, according to the judgment result, the resynchronization operation of the synchronization signal detected from the input signal and the reproducing synchronization signal is started to be performed.

That is to say, by the present invention, it becomes possible to perform the resynchronization operation using the detected synchronization signal according to the obtained state in which each time of synchronization signal detected from the input signal continuously is detected at the normal timing under the predetermined condition after the start of the interpolation of the synchronization signal.

### BRIEF DESCRIPTION OF DRAWINGS

FIG. 1 is a block diagram showing the internal configuration of a disc reproducing apparatus to which a synchronization signal detection apparatus as an embodiment of the present invention is applied;

FIG. 2 is a block diagram showing the internal configuration of the synchronization signal detection apparatus as the embodiment;

FIG. 3 is a data structure diagram showing the data structure of EFM+ data;

FIG. 4 is a timing chart for illustrating the operation obtained by the synchronization signal detection apparatus of the embodiment;

FIG. 5 is a flowchart for illustrating the operation obtained by the synchronization signal detection apparatus of the embodiment; and

FIGS. 6A-6G are timing charts for illustrating conventional forward guard operation.

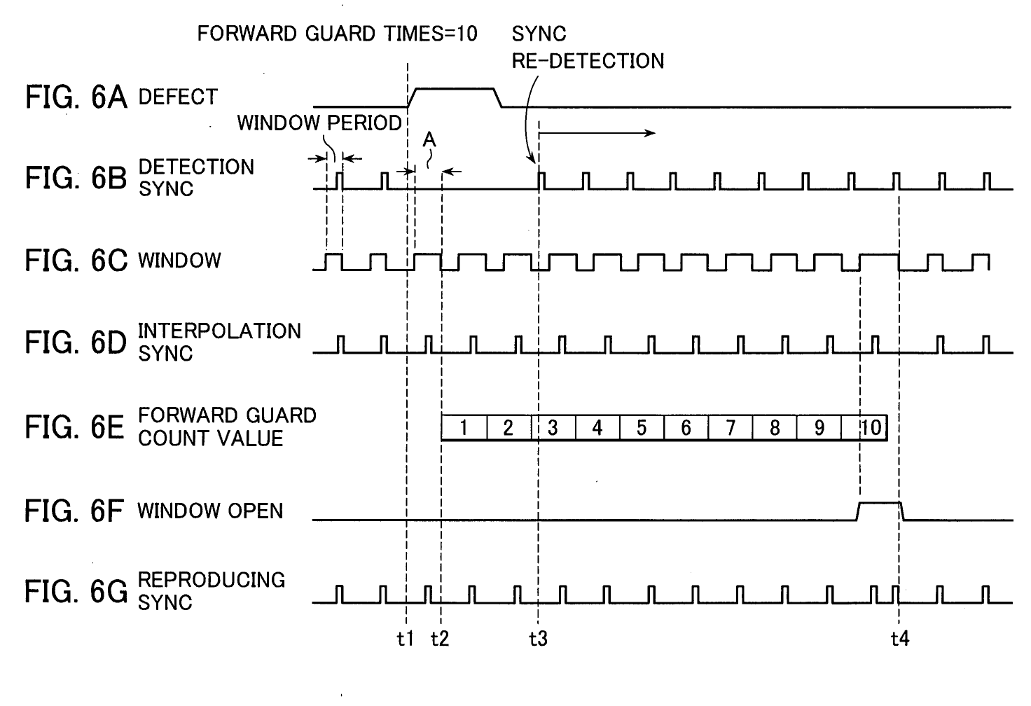

### BEST MODE FOR CARRYING OUT THE INVENTION

In the following, a case where a synchronization signal detection apparatus of the present invention is applied to a disc reproducing apparatus capable of reproducing digital data recorded on a disc recording medium is exemplified.

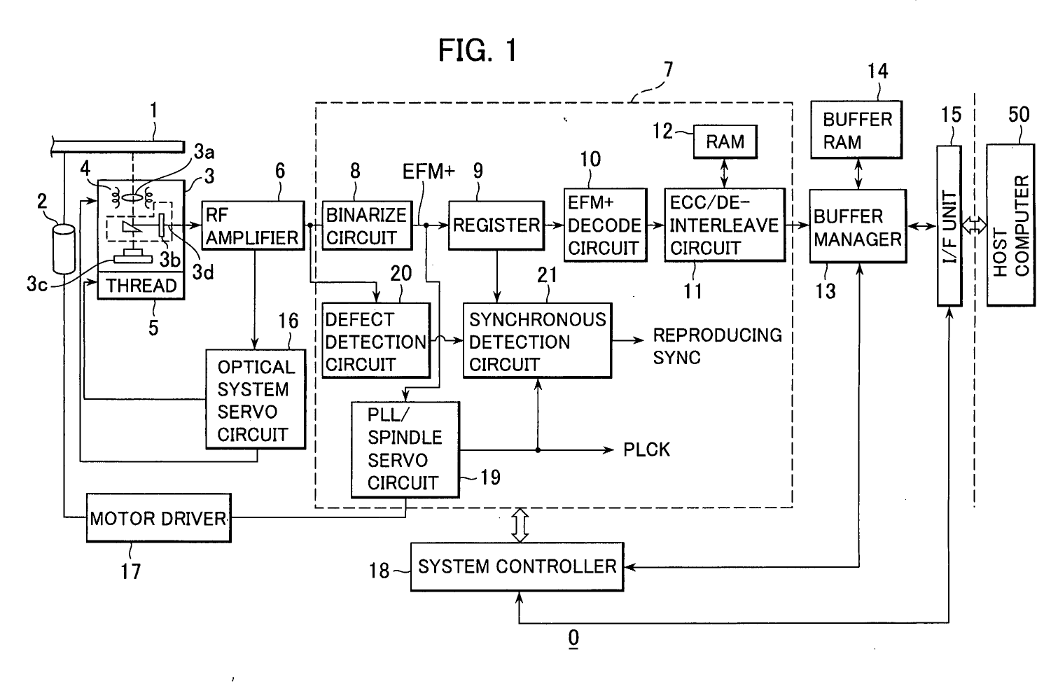

FIG. 1 shows the configuration of a disc reproducing apparatus 0, to which the synchronization signal detection apparatus as an embodiment of the present invention is applied. The disc reproducing apparatus 0 shown in this figure has a configuration capable of reproducing data correspondingly to a recordable disc such as a DVD-R, a DVD-RW and a DVD-RAM as an optical disc of a DVD format.

In this figure, a disc 1 is driven to rotate by a spindle motor 2 at the time of reproduction operation in accordance with a predetermined rotation control method such as Constant Angular Velocity (CAV), Constant Linear Velocity (CLV) and Zoned Constant Linear Velocity (ZCLV). Then, the read out of pit data recorded in a track on the disc 1 and the wobbling information of the track is performed by an optical head 3. A pit recorded as data on the track formed as a groove or a land is the so-called dye change pit or the phase change pit.

For performing the data read out operation from the disc 1 in the way described above, the optical head 3 is provided with a laser diode 3c for performing laser output, an optical system 3d composed of a polarization beam splitter, a ¼ wave plate and the like, an object lens 3a being a laser output end, a detector 3b for detecting reflected light, and the like.

The object lens 3a is held by a two-axis mechanism 4 in the state of being displaced in a radial direction of disc (tracking direction) and a direction of approaching to or receding from the disc, and the whole of the optical head 3 is set to be movable in the radial direction of the disc by a thread mechanism 5.

The information detected from the disc 1 by the reproduction operation of the above-mentioned optical head 3 is supplied to an RF amplifier 6. In this case, the RF amplifier 6 performs the amplification processing, necessary arithmetic processing and the like of the input information to obtain a reproducing RF signal, a tracking error signal, a focus error signal and the like.

A defect detection circuit 20 compares the amplitude level of the reproducing RF signal supplied from the RF amplifier 6 with an internally set threshold value to detect the case where the amplitude level is equal to or less than the threshold value. Then, when the defect detection circuit 20 detects the case where the amplitude level of the reproducing RF signal is equal to or less than the threshold value, the defect detection circuit 20 outputs a signal DEFECT to a synchronous detection circuit 21, which will be described later.

An optical system servo circuit 16 generates various servo drive signals on the basis of the tracking error signal and the focus error signal, both supplied from the RF amplifier 6, a track jump instruction and an access instruction, both supplied from a system controller 18, and the like, and controls the two-axis mechanism 4 and the thread mechanism 5 to perform focus control and tracking control.

Moreover, the reproducing RF signal obtained by the RF amplifier 6 is supplied to a binarize circuit 8 in a shown signal processing unit 7, and is output from the binarize circuit 8 in the form of the so-called EFM+ signal, which is coded by the record coding of the EFM+ system ( 8/16 modulation, RLL (2, 10)) to be supplied to a register 9 and a PLL/spindle servo circuit 19, as shown in the figure.

Moreover, the tracking error signal and the focus error signal are supplied to the optical system servo circuit 12.

The EFM+ signal supplied from the binarize circuit 8 to an EFM+ decode circuit 10 through the register 9 is demodulated in accordance with the EFM+ demodulation by the EFM+ decode circuit 10.

The EFM+ decode circuit 10 executes the demodulation processing of the input EFM+ signal at the timing according to the reproducing sync output from the synchronous detection circuit 21, which will be described later, and to PLCK supplied from the shown PLL/spindle servo circuit 19.

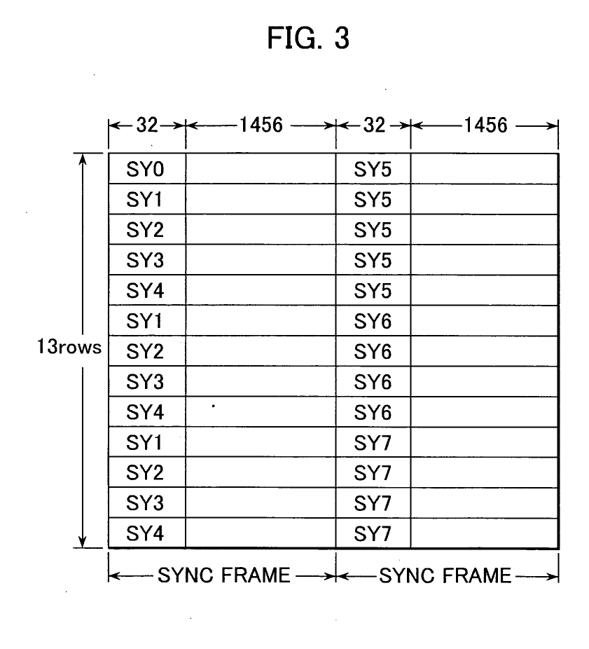

Now, the EFM+ signal supplied to the EFM+ decode circuit 10 in the way described above has a structure shown in FIG. 3.

That is to say, the EFM+ signal is composed of a set of 13 rows, each formed of two continuous frames, as shown in the figure.

Moreover, one frame is structured to have a sync pattern (synchronization signal) of any one of SY0-SY7, each having 32 bit, added to the head of each of data frames, each having 182 bytes (1456 bits), as shown in the figure. Consequently, in the EFM+ signal, the channel bit number constituting one frame including the frame sync is 1488 channel bits (1488 T).

The data demodulated by the EFM+ decode circuit 10 in accordance with the EFM+ demodulation is supplied to an ECC/de-interleave process circuit 11. The ECC/de-interleave process circuit 11 performs reading operation and writing operation of data against a RAM 12 at predetermined timing while executing error correction processing and de-interleave processing. The data received the error correction processing and the de-interleave processing thereof by the ECC/de-interleave process circuit 12 is supplied to a buffer manager 13, which will be described later.

The PLL/spindle servo circuit 19 input the EFM+ signal supplied from the binarize circuit 8 therein to operate a PLL circuit, and thereby outputs a signal PLCK as a reproducing clock synchronized with the EFM+ signal. The signal PLCK is used as a process reference clock being a master clock in the signal processing unit 7. Consequently, the operation timing of the signal processing system of the signal processing unit 7 follows the rotation speed of the spindle motor 2.

A motor driver 17 generates a motor drive signal on the basis of, for example, a spindle servo control signal supplied from the PLL/spindle servo circuit 19, and supplies the generated motor drive signal to the spindle motor 2. Consequently, the spindle motor 2 drives the disc to rotate it in order to obtain an appropriate rotation speed in accordance with a predetermined rotation control method.

The synchronous detection circuit 21 performs the operation for detecting the frame sync (frame synchronization signal) from the EFM+signal supplied from the register 9 on the basis of the signal PLCK input from the PLL/spindle servo circuit 19 as a reference clock.

Moreover, the synchronous detection circuit 21 is configured to execute also the interpolation processing of the frame sync, and the processing of window protection and the like in the way described later for the sake of the case where the omission of the sync pattern in data owing to the influence of a drop-out or jitter, or the case where the same sync pattern is detected.

Incidentally, the internal configuration of the synchronous detection circuit 21 will be described later.

The data output from the ECC/de-interleave process circuit 11 of the signal processing unit 7 in the way described above is supplied to the buffer manager 13.

The buffer manager 13 executes the memory control for storing the supplied reproduced data to a buffer RAM 14 temporarily. As a reproduced output from the disc reproducing apparatus 0, the data buffered in the buffer RAM 14 is read out and transferred to be output.

An interface (I/F) unit 15 is connected to an external host computer 50, and performs the communication of the reproduced data, various commands and the like with the host computer 50.

In this case, the buffer manager 13 performs the read-out of the necessary amount of the reproduced data temporarily stored in the buffer RAM 14, and transfers the read-out data to the interface unit 15. Then, the interface unit 15 performs the processing of the transferred reproduced data such as the packetization thereof in accordance with, for example, a predetermined data interface format, and outputs the processed data to the host computer 50 by transmitting the data thereto.

Incidentally, a read command, a write command and the other signals from the host computer 50 are supplied to the system controller 18 through the interface unit 15.

The system controller 18 is composed of a microcomputer and the like, and suitably executes control processing according to necessary operation which each functional circuit unit constituting the reproducing apparatus should execute.

Incidentally, although FIG. 1 illustrates the disc reproducing apparatus 0 connected to the host computer 50, a form of the reproducing apparatus which is not connected to the host computer 50 or the like can be adopted as the reproducing apparatus of the present invention. In that case, an operation unit and a display unit are provided, or the configuration of the interface unit for inputting and outputting data becomes different one from that shown in FIG. 1. That is to say, it is sufficient as the reproducing apparatus of the present invention that reproduction is performed according to the operation of a user, and that a terminal unit for inputting and outputting various kinds of data is formed.

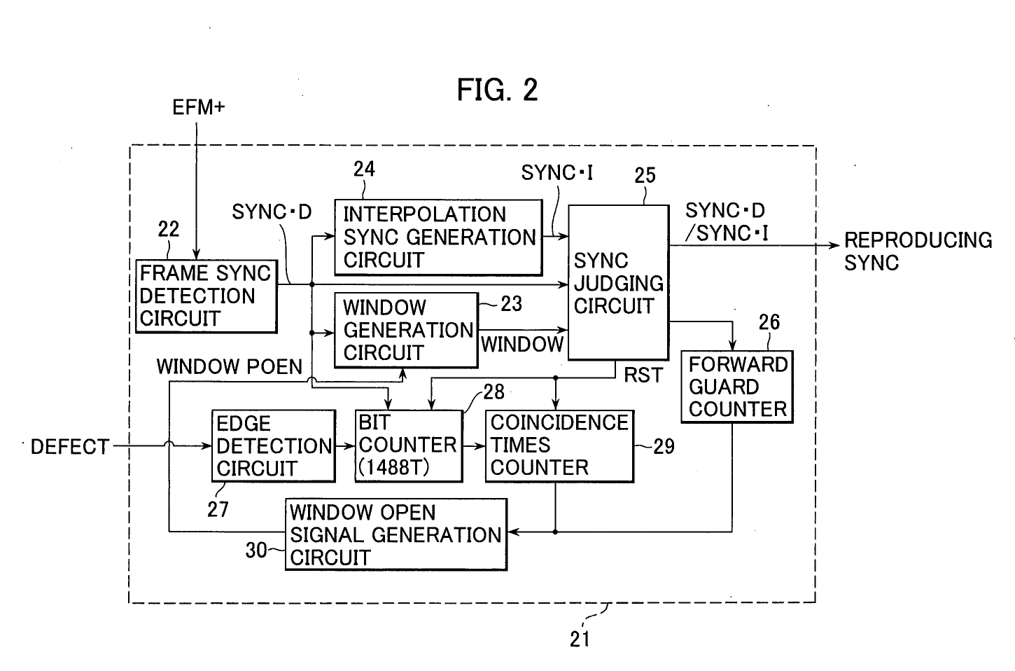

Now, the internal configuration of the above-mentioned synchronous detection circuit 21 is shown in the block diagram of FIG. 2.

In FIG. 2, the synchronous detection circuit 21 is composed of a frame sync detection circuit 22, a window generation circuit 23, an interpolation sync generation circuit 24, a sync judging circuit 25, a forward guard counter 26, an edge detection circuit 27, a bit counter 28, a coincidence time counter 29 and a window open signal generation circuit 30, as shown in the figure.

First, the EFM+ signal generated by the binarize circuit 8 described with reference to FIG. 1 is supplied to the frame sync detection circuit 22 through the register 9.

The frame sync detection circuit 22 detects the sync pattern of 32 bits arranged at the head of the frame sync as shown in FIG. 3 before from the input EFM+ signal. Then, the detection sync (SYNC D) is output to the window generation circuit 23, the interpolation sync generation circuit 24, the sync judging circuit 25 and the bit counter 28, as shown in the figure.

The window generation circuit 23 generates the signal WINDOW for setting the window period as sync detection timing on the basis of the frame sync detected by the frame sync detection circuit 22.

The signal WINDOW is generated in order that the period of its H level may be the window period.

The interpolation sync generation circuit 24 generates the interpolation sync for interpolating the reproducing sync in case of frame sync omission, or in the case where the frame sync is detected out of the period during which the signal WINDOW is the H level. The interpolation sync generation circuit 24 generates interpolation sync SYNC I synchronized with the timing of the detection sync supplied from the frame sync detection circuit 22.

The sync judging circuit 25 compares the detection sync SYNC D supplied from the frame sync detection circuit 22 with the signal WINDOW supplied from the window generation circuit 23, and thereby performs the determination about whether the frame sync is detected in the windows or not.

When the sync judging circuit 25 determines that the frame sync is detected in the windows, the sync judging circuit outputs the detected frame sync as the reproducing sync.

Moreover, besides the outputting, the sync judging circuit 25 outputs a reset signal RST for resetting the operation state of the bit counter 28, which will be described later, and the coincidence time counter 29 in response to the detection of the frame sync in the windows.

On the other hand, when the sync judging circuit 25 determines that no frame sync is detected in the windows, the sync judging circuit 25 outputs the interpolation sync SYNC I supplied from the interpolation sync generation circuit 24 as the reproducing sync.

Then, besides the outputting, the sync judging circuit 25 supplies a signal for incrementing the counted value by one to the forward guard counter 26, which will be described next, in response to the detection of no frame sync in the windows.

The forward guard counter 26 counts the number of times of the cases where the frame sync is not detected in the windows on the basis of the judgment result of the sync judging circuit 25. Then, when the counted value accords with a value set as the forward guard times in the inside of the forward guard counter 26, the forward guard counter 26 outputs a signal for instructing the output of the signal WINDOW-OPEN to the window open signal generation circuit 30.

The counted value in the forward guard counter 26 is reset when the instruction of the output of the signal WINDOW-OPEN is performed in the way described above and when sync resynchronization is performed.

Incidentally, the forward guard times in this case is set to be, for example, ten times.

The signal DEFECT is supplied from the defect detection circuit 20 shown in FIG. 1 to the edge detection circuit 27.

The edge detection circuit 27 is configured to detect the time point when the defect state is dissolved by detecting, for example, the falling edge of the supplied signal DEFECT.

The detection output of the edge detection circuit 27 is supplied to the bit counter 28.

After the dissolution of the defect state, the bit counter 28 performs the count of the bit interval of each time of the frame sync detected by the frame sync detection circuit 22. Moreover, the bit counter 28 detects whether each time of sync re-detected in such a way is obtained at a right interval prescribed in the format.

That is to say, first, when the falling edge of the defect signal is detected by the edge detection circuit 27 and the frame sync is detected by the frame sync detection circuit 22, the count operation is started. Then, the bit counter 28 counts the bit numbers until the frame sync is again detected, and detects the agreement of the counted value with the internally set predetermined comparison reference value.

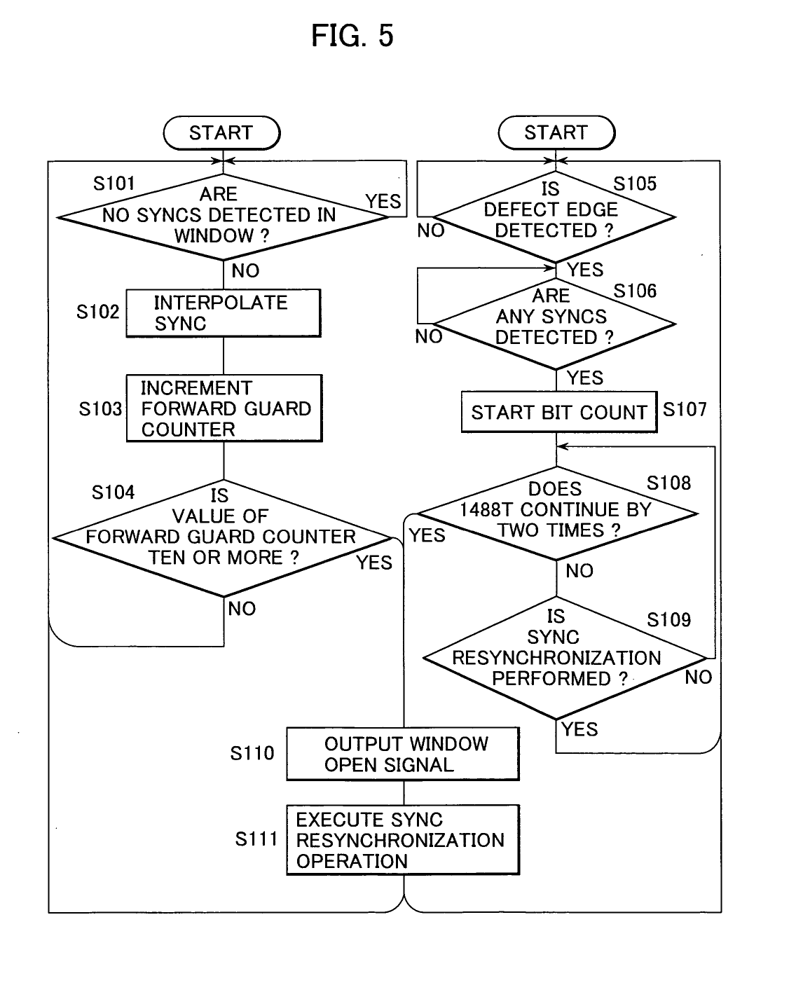

In case of the present embodiment, because the agreement with the bit interval prescribed in the DVD format shown in FIG. 5 before is detected, the comparison reference value set in the bit counter 28 in such a way is “1488” as shown in the figure.

Incidentally, the bit counter 28 operates as follows. That is to say, when sync is detected by the frame sync detection circuit 22, the bit counter 28 resets the counted value and then starts counting.

Moreover, when the reset signal RST is input from the sync judging circuit 25 in response to the detection of the frame sync in the windows in the way described above, the bit counter 28 performs the reset of its operation state. That it to say, the bit counter 28 is made to wait in its reset state of the counted value until the detection output from the edge detection circuit 27 is input and the detection sync is input.

The coincidence time counter 29 counts the times of continuous obtainment of the sync re-detected after the dissolution of the defect state at the normal interval prescribed in the format on the basis of a detection output by the bit counter 28. Then, when the counted value becomes equal to or more than a predetermined maximum value set in the inside thereof, the coincidence time counter 29 outputs a signal for instructing the output of the signal WINDOW-OPEN to the window open signal generation circuit 30. Here, it is supposed that, for example, “2” is set as the maximum value.

Incidentally, when the coincidence time counter 29 outputs the signal for instructing the output of the signal WINDOW-OPEN to the window open signal generation circuit 30 in the way described above, the coincidence time counter 29 resets its counted value.

Moreover, when the reset signal RST is input from the sync judging circuit 25 in response to the detection of the frame sync in the windows, the coincidence time counter 29 also resets the counted value.

The window open signal generation circuit 30 outputs the signal WINDOW-OPEN for opening the window to the window generation circuit 23 on the basis of the instruction signal from the forward guard counter 26 or the coincidence time counter 29.

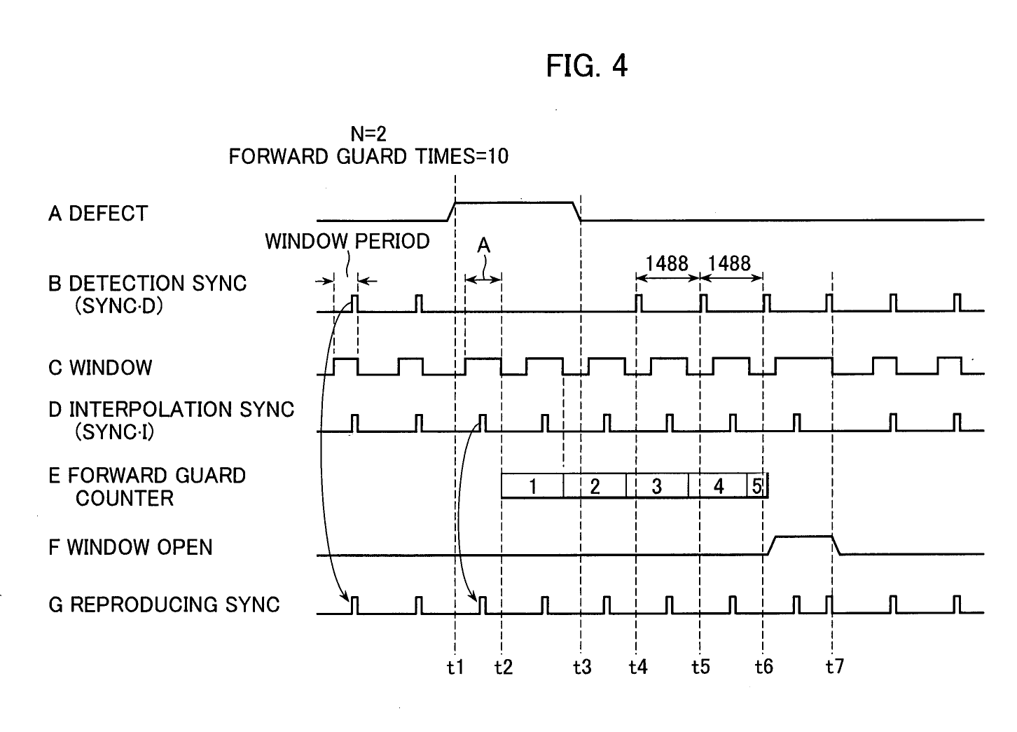

The operation obtained by the synchronous detection circuit 21 configured as above is described by the use of a timing chart shown in FIG. 4.

First, in this figure, the signal DEFECT shown in A of FIG. 4 is generated by the defect detection circuit 20 shown in FIG. 1, and the H level is output during the detection of the defect state, as shown in the figure.

Moreover, the detection sync SYNC D shown in B of FIG. 4 is a signal generated by the frame sync detection circuit 22, and a pulse of the H level is obtained according to the timing of the detection of the frame sync.

The signal WINDOW shown in C of FIG. 4 is a signal generated by the window generation circuit 23 as described above, and a period of the H level of the signal is set as the window period as shown in the figure. Only the detection sync SYNC D detected in the window period is effective as the reproducing sync.

The interpolation sync SYNC I of D in FIG. 4 is a signal generated by the interpolation sync generation circuit 24.

Moreover, E of FIG. 4 is a value of the forward guard counter 26, and the timing of the increment of the counted value is shown here.

Furthermore, the signal WINDOW-OPEN shown in F of FIG. 4 is a signal generated by the window open signal generation circuit 30, and the reproducing sync shown in G of FIG. 4 is a signal output from the sync judging circuit 25.

In FIG. 4, first, in the period before the time point t1 shown in the figure, the detection sync SYNC D is the H level in the period in which the signal WINDOW shown as the window period in the figure is the H level, and then during the period the frame sync is normally detected by the frame sync detection circuit 22.

Moreover, in this state, because the detection sync is output by the sync judging circuit 25, the reproducing sync to be supplied to the EFM+decode circuit 15 is synchronized with the timing of the detection sync SYNC D as shown in the figure.

Now, it is supposed that the amplitude of the reproducing RF signal becomes equal to or less than a predetermined value owing to, for example, a scratch on the disc and the defect detection circuit 20 detects the defect state at the time point t1 in the figure. Moreover, besides the supposition, it is supposed that the frame sync detection circuit 22 enters in the sate of not detecting the frame sync in the window period shown as a period A immediately after the time point t1.

Then, accordingly to this, the interpolation sync SYNC I generated by the interpolation sync generation circuit 24 is output from the sync judging circuit 25 for interpolating the reproducing sync. That is to say, from this time point, the forward guard operation is started.

Moreover, besides this, the sync judging circuit 25 performs the operation of the increment of the counted value of the forward guard counter 26 by one. In response to this, the value of the forward guard counter 26 becomes “one” at the time point t2 as shown in the figure.

On and after this, the value of the forward guard counter 26 is continued to be incremented by the sync judging circuit 25 in the case where no frame sync is detected in the window period.

Then, in this case, because “ten” times are set as the forward guard times as described related to FIG. 2 before, the interpolation operation of the sync described above should be performed until the time point at which the counted value becomes “ten”.

It is supposed that the signal DEFECT falls to the L level and the defect state is dissolved at the time point t3 as shown in the figure on and after the time point t2, at which no frame sync is detected in the window in the way described above.

In response to this, the falling edge of the signal DEFECT is detected by the edge detection circuit 27, and the detected output is output to the bit counter 28. Thereby, the bit counter 28 is reset for starting bit count at the time when the detection sync SYNC D is input from the frame sync detection circuit 22.

Now, it is supposed that the frame sync is again started to be detected by the frame sync detection circuit 22 at the shown time point t4. Moreover, at this time, it is supposed that the frame sync re-detected again is at the timing out of the window as shown in the figure.

First, in the case where the frame sync re-detected after the dissolution of the defect state in the way described above is at the timing out of the window, the outputting of the interpolation sync SYNC I by the sync judging circuit 25 is continued.

That is to say, in the case where the frame sync is not detected in the window period in the way described above, the above-mentioned forward guard operation is continuously performed. Then, in this case, as apparent from A of FIG. 4 and G of FIG. 4, the interpolation sync is continuously used as the reproducing sync.

Moreover, besides this, when the detected output (detection sync) by the frame sync detection circuit 22 is input into the bit counter 28 at this time point t4, the bit counter 28 starts counting at the timing of a channel clock (signal PLCK).

Then, when the frame sync is again detected at a time point t5 as shown in the figure, the bit interval from the frame sync detected at the time point t4 to the frame sync detected at the time point t5 is obtained as the counted value.

The counted value count by the bit counter 28 in such a way is compared with the comparison reference value indicating the correct bit interval prescribed in the format in the bit counter 28. That is to say, in this case, the counted value is compared with the bit number “1488” for one frame prescribed in the DVD format, as described related to FIG. 2 before.

Then, for example, in the case where the agreement of the comparison reference value and the above-mentioned counted value is detected, the detection output is supplied to the coincidence time counter 29.

When the bit counter 28 counts the bit number between the detected frame sync at the time point t5, the counted value is reset, and the count of the bit number is again started.

Then, in the case where the frame sync is again detected at a shown time point t6, the bit counter 28 is made to detect the agreement of the counted value of the bit number between these times of the frame sync with the internally set value “1488” similarly to the way described above.

Now, it is supposed that the frame sync severally detected at the time point t4 and at the time point t5 and the frame sync detected at the time point t5 and at the time point t6 are detected at the same “1488” bit interval as shown in the figure.

Then, at the time point t5 first, the agreement of the bit number between the times of the frame sync (between t4 and t5), which is counted by the bit counter 28, and the internal comparison reference value “1488” is detected, and the detected output is supplied to the coincidence time counter 29. Then, in response to this, the counted value of the coincidence time counter 29 is incremented by one.

Then, similarly also at the time point t6, the detected output indicating the agreement of the bit number between the times of the frame sync (between t5 and t6) and the comparison reference value “1488” is supplied to the coincidence time counter 29 by the bit counter 28.

The detected output is thus supplied from the bit counter 28 to the coincidence time counter 29 two times. Consequently, it is detected that the value “2” of the number of times of the continuous agreement of the coincidence time counter 29 has reached the internally set maximum value “2”.

Then, in the way described on the basis of FIG. 2 before, the detected output is supplied to the window open signal generation circuit 30, and the signal WINDOW-OPEN is supplied to the window generation circuit 23.

By the supply of the signal WINDOW-OPEN to the window generation circuit 23 in such a way, the frame sync detected at a time point t7 is detected within the H level period of the signal WINDOW (window period) as shown in the figure.

Then, in response to this, the sync judging circuit 25 determines that the frame sync is detected in the window, and the detection sync SYNC D is output from the sync judging circuit 25.

Thereby, at the time point t7, the frame sync detected by the frame sync detection circuit 22 is started to be used as the reproducing sync, as it can be found by referring to B of FIG. 4 and G of FIG. 4, and sync resynchronization is performed.

Thus, in the case where the frame sync detected after a defect dissolution has been detected continuously two times at the “1488” interval, the present embodiment performs sync resynchronization at the time point.

That is to say, in the present embodiment, in the case where it is detected that the frame sync detected after the defect dissolution has been detected twice continuously at the correct bit interval prescribed in the format in such a way, the frame sync is regarded to have been detected at the appropriate timing, and the resynchronization of sync is performed.

Thereby, the sync resynchronization can be performed more rapidly as shown in the figure in this case in comparison with the case where only the forward guard operation is performed and the sync is interpolated for the number of times corresponding to “10” times to be set as the forward guard times.

That is to say, in this case, the frame sync at the originally expected timing can be used as the reproducing sync more rapidly.

Successively, as for the operation describe above with reference to FIG. 4, the flow of the signal processing operation performed in each unit of the synchronous detection circuit 21 shown in FIG. 2 is described by using the next flowchart of FIG. 5.

First, in FIG. 5, the processing operation started from a shown Step S101 is a processing operation for realizing the forward guard operation described in FIG. 4.

That is to say, in the case where no frame sync is detected in the window, sync is interpolated by the number of times corresponding to the set forward guard times.

Accordingly, first, at shown Step S101, that the frame sync is not detected in the window is monitored.

That is to say, the sync judging circuit 25 compares the detection sync SYNC D supplied from the frame sync detection circuit 21 and the signal WINDOW supplied from the window generation circuit 23, and thereby that the frame sync is not detected in the window is determined.

Then, when that the frame sync is not detected in the window is determined in such a way, the processing operation advances to Step S102.

At Step S102, the sync judging circuit 25 outputs the interpolation sync SYNC I generated by the interpolation sync generation circuit 24 as the reproducing sync.

At succeeding Step S103, the sync judging circuit 25 outputs a signal for incrementing the value of the forward guard counter 26 by one in response to the fact that the frame sync is not detected in the window at Step S101. Then, in response to the signal, the forward guard counter 26 increments the counted value by one.

At Step S104, the forward guard counter 26 determines whether the value of the forward guard counter is equal to or more than the value “10” set inside as the forward guard times or not. When the value of the forward guard counter 26 is not equal to or more than the forward guard times, the processing operation advances to Step S101, and whether the process is in the state in which the frame sync is not detected in the window or not is judged again.

Moreover, when the value of the forward guard counter 26 is equal to or more than the forward guard times, the signal for outputting the signal WINDOW-OPEN is supplied to the window open signal generation circuit 30, and the processing operation advances to Step S110, the process at which will be described later.

Now, in the synchronous detection circuit 21 shown in FIG. 2, the operation for the sync resynchronization operation based on the detection interval of the sync on and after shown Step S105 is also performed in parallel with the processing operation for the forward guard operation shown in Step S101 to Step S104.

First, at Step S105, the edge detection circuit 27 detects, for example, the falling edge of the signal DEFECT supplied from the defect detection circuit 20 shown in FIG. 1, and thereby the edge detection circuit 27 monitors the dissolution of the defect state.

Then, at successive Step S106, the frame sync detection circuit 22 monitors the re-detection of the frame sync.

Then, at Step S107, the bit counter 28 starts bit count in response to the falling edge of the defect signal detected and output by the edge detection circuit 27, and to the detection sync detected and output by the frame sync detection circuit 22.

Then, on and after that, the bit counter 28 detects the agreement of the counted value and the internally set comparison reference value “1488” at every detection of the frame sync in the way described above. Moreover, when the agreement of the counted value and the comparison reference value “1488” is detected, the bit counter 28 supplies the detected output to the coincidence time counter 29.

At successive Step S108, it is determined whether re-detected each frame sync is obtained two times continuously at the correct bit interval (1488 T) prescribed in the format or not. That is to say, the operation at Step S108 corresponds to whether the detected output from the bit counter 28 is supplied to the coincidence time counter 29 two times continuously or not.

At Step S108, in the case where the detected output is not supplied two times continuously from the bit counter 28 to the coincidence time counter 29 to be regarded that re-detected each frame sync is not obtained at the correct 1488 T bit interval two times continuously, the processing operation advances to Step S109, and whether the sync resynchronization operation has been performed or not is determined. That is to say, whether the sync resynchronization has been performed by the above-mentioned forward guard operation or not is determined.

The operation at Step S109 corresponds to whether the bit counter 28 and the coincidence time counter 29 have received the supply of the reset signal RST from the sync judging circuit 25 or not.

Now, the reset signal RST is a signal for resetting the operation of the bit counter 28 and the coincidence time counter 29 in response to the detection of the frame sync in the window, as described before. That is to say, the reset signal RST is one for resetting the operation of the bit counter 28 and the coincidence time counter 29 when the sync is started to be detected in the window owing to, for example, the performance of the sync resynchronization operation after the start of the count operation of the bit counter 28 and the coincidence time counter 29.

In the case where the sync resynchronization has not been performed yet and the reset signal RST has not be output from the sync judging circuit 25 at Step S109, the processing operation advances to Step S108, and whether each time of the frame sync is obtained at the correct 1488 T bit interval two times continuously or not is successively determined.

Moreover, in the case where the sync resynchronization is performed and the reset signal RST is output from the sync judging circuit 25, the processing operation advances to Step S105, as shown in the figure.

That is to say, in this case, the bit counter 28 is reset to wait again the supply of the detected output (S105) from the edge detection circuit 27 and the supply (S106) of the detection sync from the frame sync detection circuit 22. Moreover, the coincidence time counter 29 similarly receives the supply of the reset signal RST from the sync judging circuit 25, and the counted value of the coincidence time counter 29 is reset.

Moreover, in the case where it is determined that each re-detected time of the frame sync is obtained at the correct 1488 T bit interval two times continuously at Step S108, the coincidence time counter 29 supplies the signal for outputting the signal WINDOW-OPEN to the window open signal generation circuit 30, and the processing operation advances to Step S110.

At Step S110, the window open signal generation circuit 30 outputs the signal WINDOW-OPEN to the window generation circuit 23 in response to the signal supplied from the forward guard counter 26 or the coincidence time counter 29.

At successive Step S111, the window generation circuit 23 opens the window on the basis of the supplied WINDOW-OPEN signal to detect the frame sync in the window.

Then, the sync judging circuit 25 outputs the detection sync SYNC D as the reproducing sync in response to the state in which the frame sync is detected in the window.

Thereby, the sync resynchronization operation is started to be performed.

When the sync resynchronization operation is thus performed at Step S11, the processing operation as the forward guard operation advances to Step S101 as shown in the figure, and it is again started to monitor that the frame sync is not detected in the window. Moreover, the processing operation as that for the other sync resynchronization operation based on the detection interval of the sync advances to Step S105 as shown in the figure, and it is again started to monitor that the falling edge of the signal DEFECT is detected.

In the way described above, according to the operation of the synchronous detection circuit 21 shown in FIG. 2, in the case where the value of the forward guard counter 26 reaches the forward guard times at Step S104, or in the case where 1488 T is detected two times continuously at Step S108, the processing operation advances to Step S110 and Step S111, and the sync resynchronization is performed.

Then, in the case where the two-time continuous agreement at 1488 T at Step S108 is detected earlier than the arrival of the value of the forward guard counter 26 to the forward guard times at Step S104, the sync resynchronization operation at Step S11l is performed earlier than the interpolation of the sync by the predetermined number of times by the forward guard operation.

Incidentally, although the description by illustration is omitted, the so-called backward guard operation for performing the compensation of the sync detection position after the resynchronization is made to be performed as the actual operation of the synchronous detection circuit 21.

That is to say, the number of times of the detection of the frame sync detected after the resynchronization in the window is counted similarly to the forward guard operation. Then, when the counted value becomes equal to or more than the predetermined number of times, it is determined that the detected frame sync is obtained at the correct timing.

In the above, the disc reproducing apparatus 0 as the present embodiment has been described.

As described above, in the disc reproducing apparatus 0 of the present embodiment, the bit counter 28 is provided in the synchronous detection circuit 21.

By means of the bit counter 28, for example, in the case where the frame sync detected again by the frame sync detection circuit 22 after the dissolution of the defect state is detected out of the window, it is judged whether each thus re-detected time of the frame sync is obtained at the correct bit interval prescribed in the format or not.

Then, in the case where each thus re-detected time of the frame sync is obtained at the correct bit interval prescribed in the format, for example, continuously two times, the signal WINDOW-OPEN is output by the window open signal generation circuit 30, and the sync resynchronization operation is performed in response to the signal WINDOW-OPEN.

That is to say, in the case where it is regarded that each time of frame sync after re-detection is detected at the correct timing in the way described above, the sync resynchronization is performed even if each time of the re-detected frame sync is detected out of the window.

Consequently, in the disc reproducing apparatus 0 of the present embodiment, in the case where each thus re-detected time of the frame sync is obtained at the correct bit interval prescribed in the format two times continuously, the sync resynchronization operation can be performed immediately.

Then, in the case where the time point at which each time of the frame sync can be obtained at the correct bit interval two times continuously is, for example, before the completion of the forward guard operation, the sync resynchronization operation can be performed earlier than that of the prior art.

That is to say, in this case, the state in which the interpolation sync having higher possibility of being at sync position different from one expected as the reproducing sync originally is used can be dissolved earlier than that by the conventional technique.

Incidentally, in the disc reproducing apparatus 0 of the present embodiment, the forward guard times set in the forward guard counter 26 shown in FIG. 2 and the number of times of the continuous agreement set in the coincidence time counter 29 are not limited to the above-mentioned numbers of times.

Moreover, in the present embodiment, the case where the disc reproducing apparatus 0 is one corresponding to the reproduction signal corresponding to the DVD format is exemplified. However, the disc reproducing apparatus 0 of the present embodiment may be made to correspond to the other formats such as those of a compact disc (CD) and a mini disc (MD: magneto-optical disk) besides the DVD.

Moreover, in this case, a channel bit number for one frame which is prescribed by the corresponding format (for example, “588” in case of corresponding to the CD format) may be set as the bit number for the sake of detecting the agreement with the bit counter 28 shown in FIG. 2.

Moreover, although the present embodiment is configured in order that the sync resynchronization operation based on the detection interval of the sync is performed in response only to the detection of the frame sync after the dissolution of the defect state, such sync resynchronization operation may be started in response to, for example, the simple detection of the frame sync out of the window.

That is to say, as the sync resynchronization operation of the present embodiment, the sync resynchronization may be simply performed in response to the fact that the frame sync detected after the start of the interpolation operation of the sync is obtained at the normal timing. Consequently, the start of such sync resynchronization operation may be one satisfying the necessary condition indicating that the frame sync is started not to be detected at the correct timing.

Moreover, the case where the synchronization signal detection apparatus of the present invention is applied to the disc reproducing apparatus 0 for reading digital data from a disc to perform the reproduction of the read digital data is exemplified in the present embodiment.

However, the synchronization signal detection apparatus of the present invention may be applied to, for example, a reception apparatus for performing the reception processing of the data in a predetermined format which data has transmitted from a transmission apparatus in a data communication system, besides such a disc reproducing apparatus.

For example, in the case where the data received by the side of the reception apparatus is audio data or moving image data, which should be output streamingly, the application of the present invention to the detection of a signal corresponding to the frame synchronization signal to be inserted into the reception data would enable the reproduced output of the reception data having better performance.

### INDUSTRIAL APPLICABILITY

As described above, the present invention performs the judgment whether synchronization signals continuously detected from an input signal are at the normal timing or not under a predetermined condition after the synchronization signals from the input signal are started not to be detected in predetermined detection periods and the interpolation of the synchronization signals is started.

Then, the resynchronization operation of the synchronization signals detected from the input signal and reproducing synchronization signals is performed according to the judgment result.

That is to say, according to the present invention, the resynchronization operation using the detected synchronization signals in response to the obtainment of the state in which each of the synchronization signals detected from the input signal continuously can be obtained at the normal timing under a predetermined condition after the start of the interpolation of the synchronization signals.

Thereby, in the case where each of the synchronization signals detected continuously from the input signal in the way described above are detected at the normal timing, the state in which the synchronization signals different from ones at the originally expected timing are used as the reproducing synchronization signals by the interpolation of the synchronization signals can be immediately dissolved.

As a result, the improvement of the reading performance of the input signal can be achieved in comparison with the case of performing only the forward guard operation.

1. A synchronization signal detection apparatus characterized by comprising:
synchronization signal detection means for inputting a signal formed by a frame in accordance with a predetermined format to detect a synchronization signal to be inserted into said frame,
interpolation means for interpolating a synchronization signal generated according to detection timing of said synchronization signal detected by said synchronization signal detection means as a reproducing synchronization signal when said synchronization signal detection means is unable to detect any synchronization signal within a predetermined detection period,
judgment means for performing judgment about whether said synchronization signal continuously detected by said synchronization signal detection means is at normal timing or not under a predetermined condition after a start of the interpolation of said synchronization signal by said interpolation means, and
resynchronization means for outputting said synchronization signal detected by said synchronization signal detection means as a reproducing synchronization signal according to a judgment result of said judgment means.

2. The synchronization signal detection apparatus as described in claim 1, characterized in that:
said judgment means is configured to perform judgment about whether each of said synchronization signal is at normal timing or not, by measuring an interval of detection timing of said synchronization signal continuously detected by said synchronization signal detection means, and by performing judgment about whether said interval of detection timing coincides with a predetermined interval and a predetermined times or more in accordance with an input signal format.

3. A synchronization signal detection method characterized by comprising the steps of executing:
a synchronization signal detection process for inputting a signal formed by a frame in accordance with a predetermined format to detect a synchronization signal to be inserted into the frame,
an interpolation process for interpolating a synchronization signal generated according to detection timing of the synchronization signal detected by the synchronization signal detection process as a reproducing synchronization signal when no synchronization signal has been able to be detected within a predetermined detection period by the synchronization signal detection process,
a judgment process for performing judgment about whether the synchronization signal continuously detected by the synchronization signal detection process is at normal timing or not under a predetermined condition after a start of the interpolation of the synchronization signal by the interpolation process, and
resynchronization process for outputting the synchronization signal detected by the synchronization signal detection process as the reproducing synchronization signal according to a judgment result of the judgment process.
